(19) United States
(12) Patent Application Publication
(10) Pub. No.: US 2013/0093907 A1
(43) Pub. Date: Apr. 18, 2013

(54) IMAGE CAPTURING APPARATUS AND METHOD OF CONTROLLING THE SAME

(71) Applicant: Mitsuo Niida, Tokyo (JP)

(72) Inventor: Mitsuo Niida, Tokyo (JP)

(73) Assignee: CANON KABUSHIKI KAISHA, Tokyo (JP)

(21) Appl. No.: 13/610,357

(22) Filed: Sep. 11, 2012

(30) Foreign Application Priority Data
Oct. 14, 2011 (JP) 2011-227439

(51) Int. Cl. H04N 5/232

(52) U.S. Cl. 348/211.4; 348/E05.042

(57) ABSTRACT

When a query instruction to query an image capturing apparatus which delivers a captured image to a plurality of external devices via a network about a parameter that can be set in the image capturing apparatus, and a setting instruction to set the parameter in the image capturing apparatus are received from a first external device, control processing to execute the query instruction and the setting instruction received from the first external device, and limit execution of the setting instruction received from a second external device after the query instruction is received from the first external device is executed.

### BACKGROUND OF THE INVENTION

1. Field of the Invention

The present invention relates to a technique of delivering a captured image via a network.

2. Description of the Related Art

A video delivery system and monitoring system which operate upon connection of a network camera to recording software which runs on a computer have been proposed in the past. A monitoring camera system capable of easily registering the preset position of a first monitoring camera in a second monitoring camera, for example, is known (Japanese Patent Laid-Open No. 2011-15040).

Also, to ensure a given communication band on a network, a decoder device which re-delivers a video signal using the protocol specified by ONVIF (Open Network Video Interface Forum Core Specification Version 1.0 November 2008) is known (Japanese Patent Laid-Open No. 2010-272943). The decoder device receives from a client a command (“Get Profile” Request) to query the transmittable video format. In response, the decoder device sends a list of transmittable video formats to the client using a command called a “Get Profiles” Response which includes one or a plurality of Media Profiles. Furthermore, the decoder device sets a Media Profile having a specific “Video Encoder Configuration” designated by the client, thereby setting an encoding scheme having a desired set of attributes.

### SUMMARY OF THE INVENTION

According to one aspect of the present invention, there is provided an image capturing apparatus which delivers a captured image to a plurality of external devices via a network, the apparatus comprising: a reception unit which receives a query instruction to query the image capturing apparatus about a parameter that can be set in the image capturing apparatus, and a setting instruction to set the parameter in the image capturing apparatus; and a control unit which performs control processing to execute the query instruction and the setting instruction received from a first external device by the reception unit, and limit execution of the setting instruction received from a second external device by the reception unit after the reception unit receives the query instruction from the first external device.

Further features of the present invention will become apparent from the following description of exemplary embodiments with reference to the attached drawings.

### BRIEF DESCRIPTION OF THE DRAWINGS

FIG. 1 is a block diagram illustrating an example of a configuration of an image capturing apparatus;

FIG. 2A is a sequence diagram for explaining the operation of the image capturing apparatus when it receives a setting command from a second client during a predetermined period;

FIG. 2B is a sequence diagram for explaining the operation of the image capturing apparatus when it receives a setting command from a first client during a predetermined period; and

FIG. 3 is a flowchart for explaining a process carried out by the image capturing apparatus.

### DESCRIPTION OF THE EMBODIMENTS

An embodiment of the present invention will be described below with reference to the accompanying drawings. Note that the embodiment to be described hereinafter is merely an example in which the present invention is actually practiced, and provides one of practical examples of configurations defined in the scope of claims.

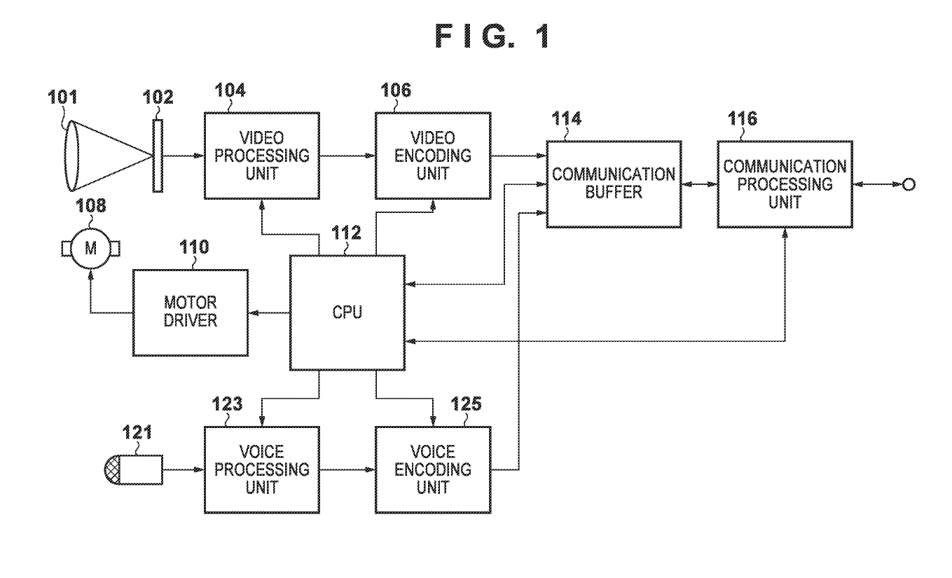

An image capturing apparatus serving as a network camera, which delivers a captured image to a plurality of external devices via a network, will be described in this embodiment. An example of the configuration of the image capturing apparatus according to this embodiment will be described first with reference to FIG. 1. Not all the constituent components shown in FIG. 1 are indispensable, and any configuration may be adopted as long as it can implement each process to be described hereinafter.

External light enters an image sensing element 102 as an optical image via an imaging optical system 101. The image sensing element 102 performs photoelectric conversion to output an image signal corresponding to this optical image.

A set of zoom lenses and a set of focus lenses (neither is shown) in the imaging optical system 101 are driven by a motor 108, which is driven under the control of a motor driver 110. The motor driver 110 is further driven under the control of a CPU 112.

A video processing unit 104 performs appropriate image processing for the image signal from the image sensing element 102 to output the image having undergone the image processing (to be simply referred to as a captured image hereinafter) to a video encoding unit 106 in the succeeding stage.

The video encoding unit 106 encodes the captured image, output from the video processing unit 104, in accordance with an image encoding scheme (for example, motion JPEG H.264 or MPEG4) to generate encoded image data. The video encoding unit 106 stores the generated encoded image data in a communication buffer 114.

A microphone 121 collects an external sound to output an audio signal corresponding to the collected sound. A voice processing unit 123 performs various types of processing for the audio signal output from the microphone 121. A voice encoding unit 125 encodes the audio signal from the voice processing unit 123 in accordance with a voice encoding scheme (for example, G.711, G.726, or ACC) currently set in the image capturing apparatus to generate encoded voice data. The voice encoding unit 125 stores the generated encoded voice data in the communication buffer 114.

A communication processing unit 116 packetizes the encoded image data and encoded voice data stored in the communication buffer 114 to deliver these data to a plurality of external devices for each packet. Also, when the communication processing unit 116 receives a command transmitted from an external device, it stores the received command in the communication buffer 114, and notifies the CPU 112 to that effect.

The CPU 112 controls the operation of each unit which constitutes the image capturing apparatus, using computer programs and data stored in a memory (not shown). Also, the CPU 112 includes a timer so as to start counting at an arbitrary timing or reset the count value and restart counting. The timer may be placed outside the CPU 112, as a matter of course. Moreover, when the CPU 112 receives a notification that a command has been stored in the communication buffer 114, it executes a process corresponding to the command. Again, the CPU 112 generates response data for the command stored in the communication buffer 114, and stores the generated response data in the communication buffer 114. Hence, the communication processing unit 116 packetizes the response data stored in the communication buffer 114 to transmit this data to an external device via a network for each packet. In this embodiment, the above-mentioned command and response data having data formats and semantics specified by, for example, the so-called ONVIF standard are transmitted/received.

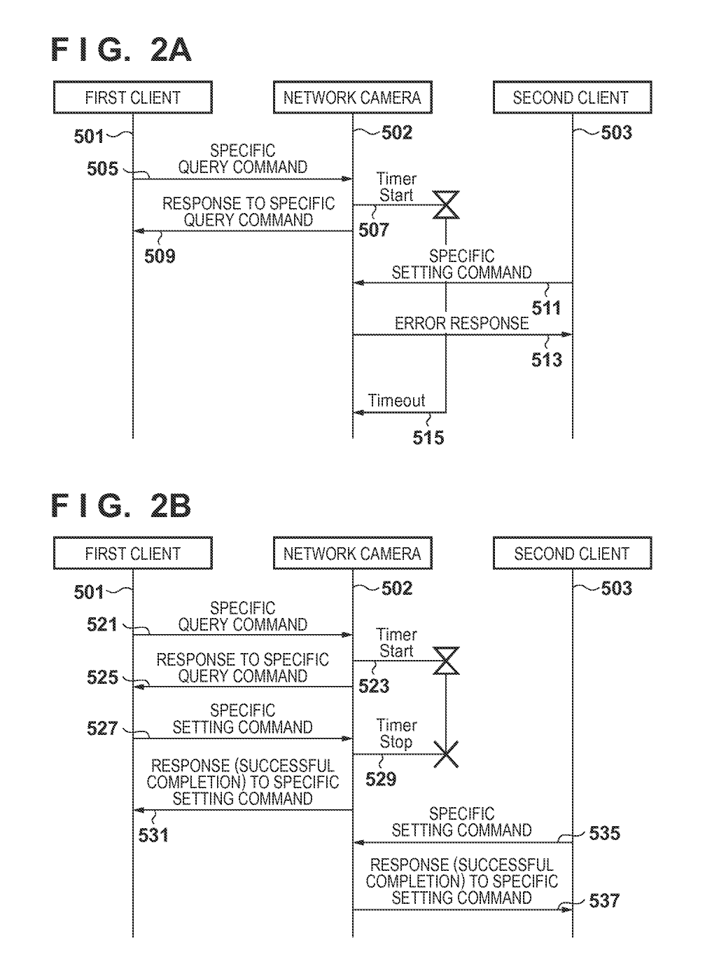

The operation of the image capturing apparatus having the above-mentioned configuration will be described next with reference to FIGS. 2A and 2B. Referring to FIGS. 2A and 2B, the image capturing apparatus is exemplified by a network camera 502. The network camera 502 can deliver a captured image and a voice to a first client (first external device) and a second client (second external device), and receive commands from each client. Note that when the network camera 502 is connected to three or more clients as well, the basic operation of the network camera 502 is the same as the following operation.

The operations of the network camera 502, first client 501, and second client 503 in the case shown in FIG. 2A will be described first.

When the first client transmits to the network camera 502 a query command 505 to query the network camera 502 parameters that can be set in the network camera 502, the network camera 502 receives the query command 505.

When the network camera 502 receives the query command 505, it transmits to the first client, which is the transmission source of the query command 505, the queried parameters as response data 509 for the query command 505. Also, the network camera 502 sends a count start instruction 507 to its internal timer, so the timer starts counting.

Assume that during the period from when the timer starts counting until the count value obtained by the timer reaches a specific value, the network camera 502 receives from the second client a setting command 511 to newly set the parameters set in the network camera 502. At this time, the network camera 502 transmits to the second client an error notification that it is impossible to change the parameters set in the network camera 502 as response data 513 for the setting command 511.

As described above, when the network camera 502 receives a setting command from a device other than the transmission source of a query command within a predetermined period after it receives the query command, it sends an error notification. Note that the network camera 502 need not send an error notification or a response to a query from the second client.

In this way, the image capturing apparatus according to this embodiment executes a setting command received from the first client after it receives a query command from it. Also, the image capturing apparatus according to this embodiment controls to limit execution of a setting command received from the second client after it receives a query command from the first client.

When the count value obtained by the timer reaches a specific value, the timer sends a notification 515 indicating a timeout to the CPU 112 of the network camera 502, so the network camera 502 becomes ready to accept a setting command again.

Note that when the network camera 502 receives a query command from the second client within the above-mentioned predetermined period after it receives a query command from the first client, it may send a response to the query command. That is, the network camera 502 can notify the second client of parameters queried by the second client as response data.

Alternatively, when the network camera 502 receives a query command from the second client within a predetermined period, it may send an error response to the second client. Again, the network camera 502 may notify the second client that it cannot execute either a query command or a setting command from the second client (it is busy).

The operations of the network camera 502, first client 501, and second client 503 in the case shown in FIG. 2B will be described next.

When the first client transmits a query command 521 to the network camera 502, the network camera 502 receives the query command 521. The network camera 502 transmits, to the first client, which is the transmission source of the query command 521, the queried parameters as response data 525 for the query command 521. Also, the network camera 502 sends a count start instruction 523 to its internal timer, so the timer starts counting.

When the network camera 502 receives a setting command 527 from the first client during the period from when the timer starts counting until the count value obtained by the timer reaches a specific value, it sends a count stop instruction 529 to the timer. Upon this operation, the timer resets the count value to stop counting. Also, the network camera 502 changes the parameters set in the network camera 502 based on the setting command 527, and transmits response data 531 indicating to that effect to the first client.

Assume that the network camera 502 then receives a setting command 535 from the second client. At this time, the network camera 502 changes the parameters set in the network camera 502 based on the setting command 535, and transmits response data 537 indicating to that effect to the second client.

As described above, when the network camera 502 receives a setting command from the transmission source of a query command within a predetermined period after it receives the query command, it executes a setting process corresponding to the received setting command until it receives the next query command.

Note that the above-mentioned query command is applicable to a command associated with setting of video encoding based on ONVIF, such as a “Get Video Encoder Configuration” command. The above-mentioned query command is also applicable to a “Get Video Encoder Configuration Options” command.

Also, the above-mentioned setting command is applicable to an ONVIF command such as an “Add Video Encoder Configuration” command or a “Remove Video Encoder Configuration” command. The above-mentioned setting command is also applicable to a “Set Video Encoder Configuration” command.

Assume, for example, that a “Get Video Encoder Configuration Options” command is transmitted from the first client to the network camera 502 as the query command 505 in the case shown in FIG. 2A. In this case, the network camera 502 transmits to the first client the following parameters that can be set in the network camera 502 as the response data 509. The response data 509 is transmitted using a “Get Video Encoder Configuration Options” response.

<Motion JPEG Parameters>

160×120, 320×240, 640×480, and 1,280×960 are used as resolution parameter values, and frame rates of 1 to 30 frames per second are used as frame rate parameter values.

<H.264 Parameters>

320×240, 640×480, and 1,280×960 are used as resolution parameter values, and frame rates of 1 to 30 frames per second are used as frame rate parameter values.

In this manner, transmitting encoding scheme-specific resolution parameter values and frame rate parameter values to the first client as the response data 509 makes it possible to offer options for the encoding scheme, resolution, and frame rate to the first client. Hence, the first client can select from these options an encoding scheme, resolution, and frame rate to be set in the network camera 502. The first client can then transmit to the network camera 502 a setting command to set the selected encoding scheme, resolution, and frame rate in the network camera 502.

Assume herein that the second client transmits to the network camera 502 a setting command 511 to set a resolution of 1,280×960, a frame rate of 30 frames per second, and the H.264 encoding scheme in the network camera 502. The setting command 511 is an “Add Video Encoder Configuration” command.

At this time, the network camera 502 is assumed to be able to deliver only one type of H.264 stream. On this assumption, the network camera 502 returns an error notification to the second client as the response data 513, as described above. Also, the network camera 502 is assumed to be able to deliver a plurality of types of motion JPEG videos. On this assumption, when the second client performs motion JPEG setting, normal video delivery setting is performed.

Assume that the first client changes parameters associated with H.264 in response to an “Add Video Encoder Configuration” command as the setting command 527 in the case shown in FIG. 2B. In this case, the network camera 502 resets the timer to stop counting, changes the parameters in accordance with the setting command 527, and transmits the response data 531 indicating to that effect to the first client. Assume that the second client then changes the parameters associated with H.264 in response to an “Add Video Encoder Configuration” command as the setting command 535. In this case, the network camera 502 changes the parameters in accordance with the setting command 535, and transmits the response data 537 indicating to that effect to the second client.

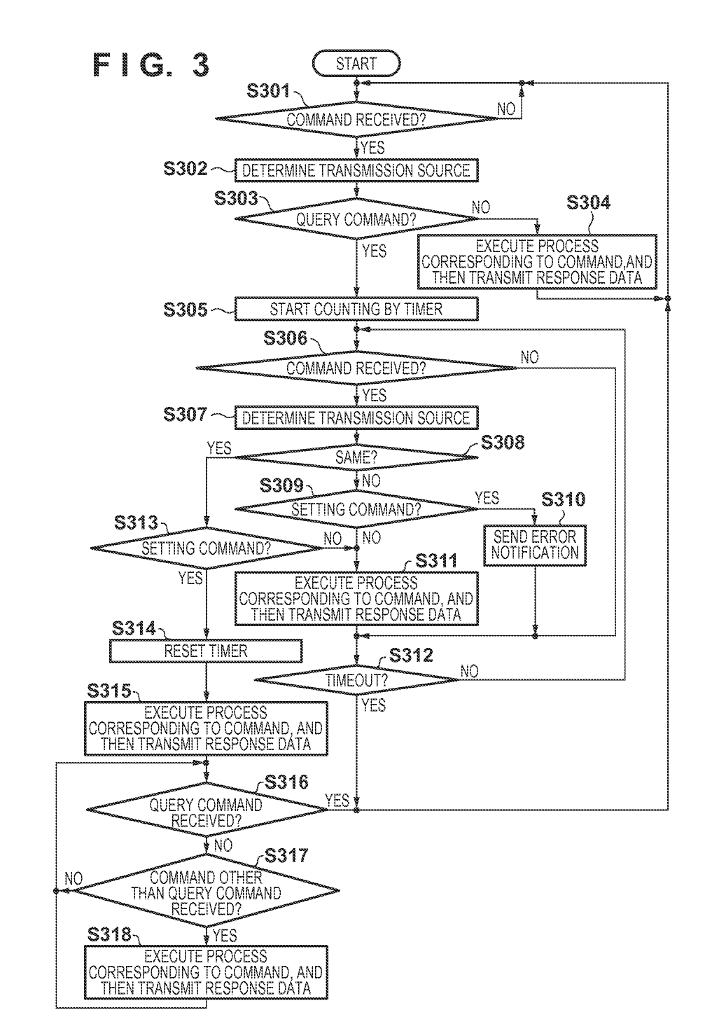

A process by the image capturing apparatus according to this embodiment will be described next with reference to the flowchart shown in FIG. 3. Note that computer programs and data for causing the CPU 112 to execute the flowchart shown in FIG. 3 are stored in an internal memory (not shown) of the image capturing apparatus. Hence, the CPU 112 executes the process according to the flowchart shown in FIG. 3, using the computer programs and data stored in this memory.

If the CPU 112 receives from the communication processing unit 116 a notification that a command (first command) has been stored in the communication buffer 114, the process advances from step S301 to step S302. In step S302, the CPU 112 determines the transmission source of the first command. Although a method of determining the transmission source of the first command is not limited to a specific method, this determination is typically done using, for example, User Token based on the Web Service Security standards.

In step S303, the CPU 112 determines whether the first command received in step S301 is a query command. If YES is determined in step S303, the process advances to step S305; otherwise, the process advances to step S304.

In step S304, the CPU 112 executes a process corresponding to the first command, and generates response data indicating, for example, successful completion of the process and the process result. The CPU 112 controls the communication processing unit 116 to transmit the generated response data to the transmission source determined in step S302.

In step S305, the CPU 112 sends a count start instruction to its internal timer, so the timer starts counting.

If the CPU 112 receives from the communication processing unit 116 a notification that another command (second command) has been stored in the communication buffer 114, the process advances from step S306 to step S307. On the other hand, if the CPU 112 receives no notification that a second command has been stored in the communication buffer 114, the process advances from step S306 to step S312.

In step S312, the CPU 112 determines whether it receives from the timer a “timeout” notification that the count value has reached a specific value. If YES is determined in step S312, the process returns to step S301; otherwise, the process returns to step S306.

On the other hand, in step S307, the CPU 112 determines the transmission source of the second command in the same way as in step S302.

In step S308, the CPU 112 determines whether the transmission source (the transmission source of the first command) determined in step S302 is the same as the transmission source (the transmission source of the second command) determined in step S307. If YES is determined in step S308, the process advances to step S313; otherwise, the process advances to step S309.

In step S309, the CPU 112 determines whether the second command is a setting command. If YES is determined in step S309, the process advances to step S310; otherwise, the process advances to step S311.

In step S311, the CPU 112 executes a process corresponding to the second command, and generates response data indicating, for example, successful completion of the process and the process result. The CPU 112 controls the communication processing unit 116 to transmit the generated response data to the transmission source determined in step S307.

On the other hand, in step S310, the CPU 112 controls the communication processing unit 116 to transmit to the transmission source determined in step S307 an error notification that it is impossible to change the parameters set in the network camera 502.

However, in step S313, the CPU 112 determines whether the second command is a setting command. If YES is determined in step S313, the process advances to step S314; otherwise, the process advances to step S311.

In step S314, the CPU 112 sends a count stop instruction to the timer, so the timer resets the count value to stop counting.

In step S315, the CPU 112 executes a process corresponding to the second command, and generates response data indicating, for example, successful completion of the process and the process result. The CPU 112 controls the communication processing unit 116 to transmit the generated response data to the transmission source determined in step S307.

If the CPU 112 receives from the communication processing unit 116 a notification that still another command (third command) has been stored in the communication buffer 114, and the third command is a query command, the process returns from step S316 to step S301. On the other hand, if the CPU 112 receives from the communication processing unit 116 no notification that a third command has been stored in the communication buffer 114, or if it receives from the communication processing unit 116 a notification that a third command has been stored in the communication buffer 114, but the third command is not a query command, the process advances from step S316 to step S317.

If the CPU 112 receives from the communication processing unit 116 no notification that a third command has been stored in the communication buffer 114, the process returns from step S317 to step S316. On the other hand, if the CPU 112 receives from the communication processing unit 116 a notification that a third command has been stored in the communication buffer 114, and the third command is other than a query command, the process advances from step S317 to step S318.

In step S318, the CPU 112 executes a process corresponding to the third command, and generates response data indicating, for example, successful completion of the process and the process result. The CPU 112 controls the communication processing unit 116 to transmit the generated response data to the transmission source of the third command.

In the above-mentioned embodiment, the process in step S318 is repeatedly executed until the next query command is received after the timer is reset in step S314. However, the end condition of the process in step S318 is not limited to this, and the process in step S318 may be repeatedly executed until, for example, a specific time elapses (the timer measures the specific time) after the timer is reset.

The image capturing apparatus according to this embodiment can reliably execute setting designated by a client which has made a query first among a plurality of clients, when the network camera is connected to the plurality of clients.

A network camera incapable of delivering a video which is encoded in accordance with H.264 and has another resolution or frame rate attribute when an H.264 stream starts to be transmitted to one client, for example, will be described.

First, the first client queries the network camera options for the encoding scheme. Assume that the second client then requests to deliver an H.264 video having SXGA size. In this case, the network camera performs setting to deliver an H.264 video having SXGA size.

As described above, the network camera can deliver only a video which is encoded in accordance with H.264 and has one set of attributes (resolution or frame rate).

Therefore, when the first client requests to deliver an H.264 video having VGA size after the delivery request from the second client, a request to deliver an H.264 video having VGA size fails.

The image capturing apparatus according to the above-mentioned embodiment sends an error response to a setting command received from the second client within a predetermined period after it receives a query command from the first client. This makes it possible to reliably execute setting designated by a client which has made a query first among a plurality of clients.

Also, according to the above-mentioned embodiment, when the network camera can deliver a video which is encoded in accordance with a second encoding scheme (for example, motion JPEG) different from H.264 and has a plurality of sets of attributes, it can accept a request to deliver a video encoded in accordance with the second encoding scheme, which is issued from the second client within the above-mentioned predetermined period.

Moreover, the image capturing apparatus according to the above-mentioned embodiment can prevent the occurrence of so-called livelock, in which it becomes impossible to end a setting operation as a plurality of clients alternately repeat their desired settings.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-227439 filed Oct. 14, 2011, which is hereby incorporated by reference herein in its entirety.

What is claimed is:

1. An image capturing apparatus which delivers a captured image to a plurality of external devices via a network, the apparatus comprising:
a reception unit which receives a query instruction to query the image capturing apparatus about a parameter that can be set in the image capturing apparatus, and a setting instruction to set the parameter in the image capturing apparatus; and
a control unit which performs control processing to execute the query instruction and the setting instruction received from a first external device by said reception unit, and limit execution of the setting instruction received from a second external device by said reception unit after said reception unit receives the query instruction from the first external device.

2. The apparatus according to claim 1, wherein when said reception unit receives the query instruction from the second external device after receiving the query instruction from the first external device, said control unit executes the setting instruction received from the first external device, and limits execution of the setting instruction received from the second external device.

3. The apparatus according to claim 1, wherein when said reception unit receives from the second external device a setting instruction to instruct the image capturing apparatus to deliver an image, encoded in accordance with a first encoding scheme, after receiving the query instruction from the first external device, said control unit limits execution of the setting instruction received from the second external device, and when said reception unit receives from the second external device a setting instruction to instruct the image capturing apparatus to deliver an image, encoded in accordance with a second encoding scheme, after receiving the query instruction from the first external device, said control unit performs control processing to execute the setting instruction received from the second external device.

4. The apparatus according to claim 1, wherein said control unit performs control processing to limit execution of the setting instruction received from the second external device before said reception unit receives the setting instruction from the first external device after receiving the query instruction from the first external device.

5. The apparatus according to claim 1, wherein said control unit performs control processing to limit execution of the setting instruction received from the second external device within a predetermined period after said reception unit receives the query instruction from the first external device.

6. The apparatus according to claim 1, wherein the parameter includes one of an encoding scheme of an image captured by the image capturing apparatus, a resolution of the captured image, and a frame rate at which the captured image is delivered.

7. The apparatus according to claim 1, wherein said control unit sends an error response to the setting instruction received from the second external device by said reception unit after said reception unit receives the query instruction from the first external device.

8. A method of controlling an image capturing apparatus which delivers a captured image to a plurality of external devices via a network, the method comprising:
a reception step of receiving a query instruction to query the image capturing apparatus about a parameter that can be set in the image capturing apparatus, and a setting instruction to set the parameter in the image capturing apparatus; and
a control step of performing control processing to execute the query instruction and the setting instruction received from a first external device in the reception step, and limit execution of the setting instruction received from a second external device in the reception step after the query instruction is received from the first external device in the reception step.

9. The method according to claim 8, wherein when the query instruction is received from the second external device in the reception step after the query instruction is received from the first external device in the reception step, a process of executing the setting instruction received from the first external device, and limiting execution of the setting instruction received from the second external device is executed in the control step.

10. The method according to claim 8, wherein in the control step, when the setting instruction to instruct the image capturing apparatus to deliver an image encoded in accordance with a first encoding scheme is received from the second external device in the reception step after the query instruction is received from the first external device in the reception step, control processing to limit execution of the setting instruction received from the second external device is executed, and when the setting instruction to instruct the image capturing apparatus to deliver an image encoded in accordance with a second encoding scheme is received from the second external device in the reception step after the query instruction is received from the first external device in the reception step, control processing to execute the setting instruction received from the second external device is executed.

11. The method according to claim 8, control processing to limit execution of the setting instruction received from the second external device before the setting instruction is received from the first external device in the reception step after the query instruction is received from the first external device in the reception step is executed.

12. A non-transitory computer-readable storage medium recording a program for causing a computer which delivers a captured image to a plurality of external devices via a network to execute:
a reception step of receiving a query instruction to query the computer about a parameter that can be set in the computer, and a setting instruction to set the parameter in the computer; and
a control step of performing control processing to execute the query instruction and the setting instruction received from a first external device in the reception step, and limit execution of the setting instruction received from a second external device in the reception step after the query instruction is received from the first external device in the reception step.

13. The medium according to claim 12, wherein the medium records the program for causing, in the control step, the computer to execute, when the query instruction is received from the second external device in the reception step after the query instruction is received from the first external device in the reception step, a process of executing the setting instruction received from the first external device, and limiting execution of the setting instruction received from the second external device.

14. The medium according to claim 12, wherein the medium records the program for causing, in the control step, the computer to execute, when the setting instruction to instruct the computer to deliver an image encoded in accordance with a first encoding scheme is received from the second external device in the reception step after the query instruction is received from the first external device in the reception step, control processing to limit execution of the setting instruction received from the second external device, and execute, when the setting instruction to instruct the computer to deliver an image encoded in accordance with a second encoding scheme is received from the second external device in the reception step after the query instruction is received from the first external device in the reception step, control processing to execute the setting instruction received from the second external device.

15. The medium according to claim 12, wherein the medium records the program for causing, in the control step, the computer to execute a process of limiting execution of the setting instruction received from the second external device before the setting instruction is received from the first external device in the reception step after the query instruction is received from the first external device in the reception step.
